(19) United States
(12) Patent Application Publication
(10) Pub. No.: US 2012/0136690 A1
(43) Pub. Date: May 31, 2012

(54) Delivery Management Effort Allocation

(75) Inventors: Saeed Bagheri, Croton on Hudson, NY (US); Krishna Ratakonda, Yorktown Heights, NY (US); Rose Williams, Wappinger Falls, NY (US)

(73) Assignee: INTERNATIONAL BUSINESS MACHINES CORPORATION, Armonk, NY (US)

(21) Appl. No.: 12/956,412

(22) Filed: Nov. 30, 2010

(51) Int. Cl. G06Q 10/00

(52) U.S. Cl. 705/7.22; 705/7.28

(57) ABSTRACT

Techniques for estimating future health of a project are provided. The techniques include defining a set of financial health metrics that represent a proximity of a current state of a project to that of a goal project, defining a parametric evolution model comprising parameters, wherein the parametric evolution model governs a relationship between current data of the set of financial health metrics and current project health in relation to past data of the set of financial health metrics, determining a value of each of the parameters of the parametric evolution model using an optimization problem, and using the value of each of the parameters of the parametric evolution model and the current data of the set of financial health metrics and current project health in relation to past data of the set of financial health metrics to estimate the future health of the project.

### CROSS-REFERENCE TO RELATED APPLICATIONS

The present application is related to U.S. patent application entitled “Determining Maturity of an Information Technology Maintenance Project During a Transition Phase,” identified by attorney docket number YOR920100521US1 and filed concurrently herewith, the disclosure of which is incorporated by reference herein in its entirety.

### FIELD OF THE INVENTION

Embodiments of the invention generally relate to information technology, and, more particularly, to delivery management.

### BACKGROUND OF THE INVENTION

A project undergoes delivery management reviews (at different levels) in its life cycle. The breadth, level and frequency of reviews can depend on the project's financial performance. For example, a project with solid performance and above-expectation return may have few reviews in its life cycle, but a project with consistent negative gross profit may experience continuous scrutiny from various management levels.

A challenge in delivery management is allocating the management effort to various projects and ensuring that the proper delivery management balance is maintained across a portfolio. In many scenarios, by way of example, typically no more than 20% of the projects in a portfolio can undergo delivery management review in a quarter. Therefore, proper selection of projects to review in a quarter is important.

One aspect is selecting projects to undergo delivery review is a project's financial outlook. Accordingly, the ability to predict the financial status of projects in a portfolio can significantly facilitate the process of effort allocation in delivery management. For example, knowing the estimated net (or inception-to-date) gross profit for each project in a portfolio in the next three months (that is, next quarter) can possibly guide a delivery management effort allocation problem.

### SUMMARY OF THE INVENTION

Principles and embodiments of the invention provide techniques for delivery management effort allocation. An exemplary method (which may be computer-implemented) for estimating future health of a project, according to one aspect of the invention, can include steps of defining a set of financial health metrics that represent a proximity of a current state of a project to that of a goal project, defining a parametric evolution model comprising parameters, wherein the parametric evolution model governs a relationship between current data of the set of financial health metrics and current project health in relation to past data of the set of financial health metrics, determining a value of each of the parameters of the parametric evolution model using an optimization problem, and using the value of each of the parameters of the parametric evolution model and the current data of the set of financial health metrics and current project health in relation to past data of the set of financial health metrics to estimate the future health of the project.

One or more embodiments of the invention or elements thereof can be implemented in the form of a computer product including a tangible computer readable storage medium with computer useable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a graph depicting profit estimation for a project at months 10, 11 and 12, according to an aspect of the invention;

FIG. 2 is a graph depicting profit estimation for a project at months 10, 11 and 12, according to an aspect of the invention;

FIG. 3 is a block diagram illustrating an example embodiment, according to an aspect of the invention;

FIG. 4 is a flow diagram illustrating techniques for estimating future health of a project, according to an embodiment of the invention

FIG. 5 is a flow diagram illustrating techniques for estimating future health of a project, according to an embodiment of the invention; and

FIG. 6 is a system diagram of an exemplary computer system on which at least one embodiment of the invention can be implemented.

### DETAILED DESCRIPTION OF EMBODIMENTS

Principles of the invention include delivery management effort allocation using minimum variance gross profit estimation. One or more embodiments of the invention include using two time dimension, namely, seasonal variation and project phase variation. Also, one or more embodiments of the invention can include managing portfolios of items such as, for example, financial considerations, large numbers of projects, equipment maintenance, etc.

Accordingly, as described herein, one or more embodiments of the invention include techniques for generating an estimate of optimum assignment of delivery effort to a portfolio of projects based on the predicted state of financial heath of the projects. The expected future gross profit as well as standard deviation of the future gross profit for each project in the portfolio can be estimated for any arbitrary future period of time (for example, number of future months or quarters). As such, one or more embodiments of the invention estimate the profit of a given project at the next time unit using the measurement of the same attribute at an earlier time unit for the same project, as well as all other projects in that category.

By way of example, let the index i represent the time. Also, let the current time be i=n. Consequently, one or more embodiments of the invention include estimating the value of:

Xₙ₊₁^{p}=Rₙ₊₁^{p}−Cₙ₊₁^{p} (1)

where X is the net profit, R is the revenue and C is the cost. Let the revenue and cost be random events and Rᵢ and Cᵢ be the independent reading of those events at time i. At time i=n, all of theses random variables with indices i≦n are already measured and known. Thus, assuming a linear estimation approach, one or more embodiments of the invention can include formulating the revenue estimation at time n+1 as:

$${\tilde{X}}_{n + 1}^{p} = {\sum }_{i = 1}^{n} ( {a}_{i}^{p} {R}_{i}^{p} - {b}_{i}^{p} {C}_{i}^{p} ) + {d}^{p} \qquad ( 2 )$$

where coefficients aᵢ, bᵢ and d are to be determined (via equation 3). In one or more embodiments of the invention, this problem can be formulated as a best (least variance) unbiased estimator:

$$[ {a}^{p} , {b}^{p} , {d}^{p} ] = argmin \{ var ( {X}_{n + 1}^{p} - {\sum }_{i = 1}^{n} ( {a}_{i}^{p} {R}_{i}^{p} - {b}_{i}^{p} {C}_{i}^{p} ) - {d}^{p} ) \} \qquad ( 3 )$$

Problem (3) can also be shown to be equivalent to a linear least square estimation problem. This problem can be solved once the model that relates the revenue and cost random variables in the past to those of future is defined. In one or more embodiments of the invention, the problem can be modeled using a future to past perspective. In particular, for any time 1≦i≦n:

Rᵢ^{p}=Rₙ₊₁^{p}+Rₙ₊₁^{p}Wᵢ^{R}

Cᵢ^{p}=Cₙ₊₁^{p}+Cₙ₊₁^{p}Wᵢ^{C} (4)

Here, Wᵢ^{R} is a random variable representing the revenue error at time i and Wᵢ^{C} is a random variable representing the cost error at time i. These errors correspond to the deviation of the revenue and cost measurement in the past from the future observation.

There are two notable points in the calculation of the mean and variance of the error random variables. First, one or more embodiments of the invention include not restricting itself to the current project only. In other words, one or more embodiments of the invention use data from all previous projects in the same class. Moreover, when considering the error random variable at time i, one or more embodiments of the invention include observing that here, i reflects a relative time, and should be considered as such when calculating the statistical properties of this error random variables. In particular, it can be written:

$$\begin{matrix}\begin{matrix}E ( {W}_{i}^{R} ) = {μ}_{{W}_{i}^{R}} \\ = \frac{1}{‖ {J}_{i} ‖} {\sum }_{j ∈ {J}_{i}} \frac{{R}_{j} - {R}_{j + i}}{{R}_{j + i}}\end{matrix} & ( 5 ) \\ \begin{matrix}var ( {W}_{i}^{R} ) = {σ}_{{W}_{i}^{R}}^{2} \\ = \frac{1}{‖ {J}_{i} ‖} {\sum }_{j ∈ {J}_{i}} {( \frac{{R}_{j} - {R}_{j + i}}{{R}_{j + i}} - {μ}_{{W}_{i}^{R}} )}^{2}\end{matrix} & ( 6 )\end{matrix}$$

There are multiple rational behind this model. For example, the model relates past observation to future measurements. Also, the model allows for formalization of historical effect of different past observations to future observation through the error random variables. Moreover, these error random variables are designed in a normalized way, and as such allow the historic data for different projects to be used interchangeably. Specifically, in one or more embodiments of the invention, the error variables do not have the superscript of p to restrict them to a given project. Rather, the error can be common across a given project class that is under consideration.

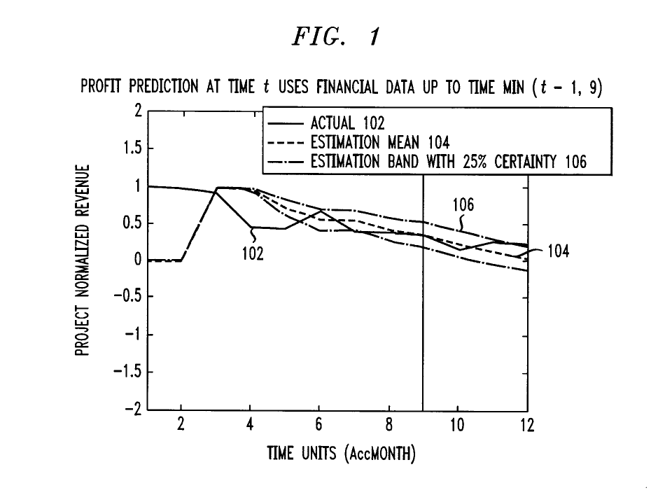

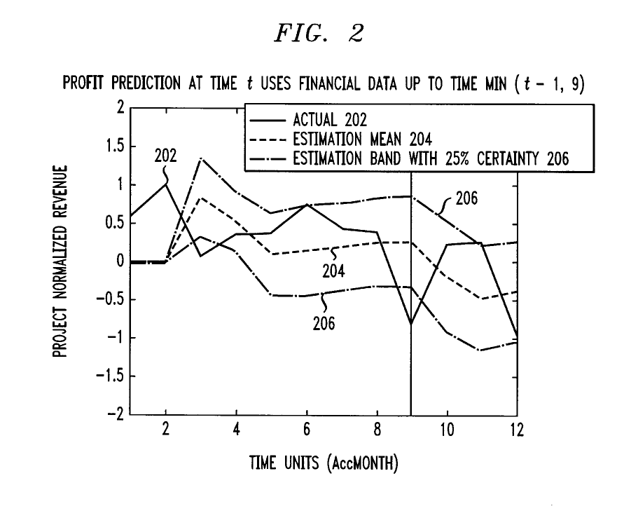

Applicability of one or more embodiments of the invention can be illustrated via the example depicted in FIG. 1 and FIG. 2. FIG. 1 is a graph depicting profit estimation for a project at months 10, 11 and 12, according to an aspect of the invention. The project in FIG. 1 has relatively smooth behavior. FIG. 2 is a graph depicting profit estimation for a project at months 10, 11 and 12, according to an aspect of the invention. The project in FIG. 2 has relatively erratic behavior.

FIG. 1 and FIG. 2 present the result of two examples when profit estimation is done for three future months. The solid curve in these figures (curve 102 in FIG. 1 and curve 202 in FIG. 2) is the measured gross profit normalized by maximum observed gross profit. The uniformly-dashed curve (curve 104 in FIG. 1 and curve 204 in FIG. 2) in these plots is the estimation of the gross profit. For estimation from month 2 to 9, one or more embodiments of the invention can use the data up to one month before (for example, data up to month 7 for estimation in month 8). However, for estimation in months 10, 11 and 12, only the data from month 1 up to and including month 9 has been used. This simulates the situation when project managers would like to assess future status of these projects when they are at the end of month 9.

The multi-dashed curves (curve 106 in FIG. 1 and curves 206 in FIG. 2) in these graph represents the 25% confidence band. In other words, with probability of 0:25, the profit remains within this band based on the prediction. Note that no estimation is done for month 1, as there is no prior data available.

Once a project's profit estimate for future is determined, a variety of actionable conclusions can be drawn. For example, one strategy can include sorting the projects according to their estimated profit and recommending the projects with the highest chance of risk for review process. Another example scenario is to have an active list of projects and a dynamic list of at-risk projects available, and whenever a project review slot becomes available, the project that is the most at risk is sent to review.

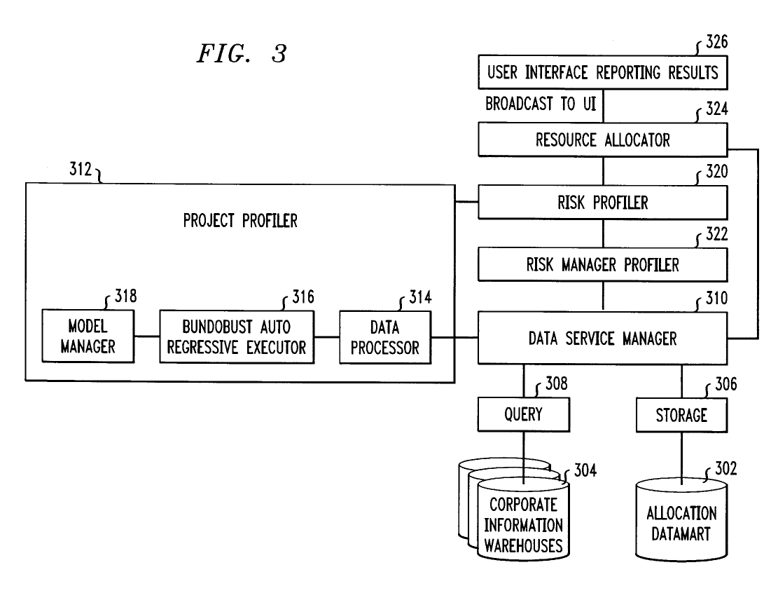

FIG. 3 is a block diagram illustrating an example embodiment, according to an aspect of the invention. By way of illustration, FIG. 3 depicts an allocation datamart module 302, a corporate information warehouses module 304, a storage manager module 306, a query executor module 308, a data service manager module 310, and a project profiler module 312, which includes a data processor module 314, a Bundobust auto regressive executor module 316 and a model manager module 318. FIG. 3 also depicts a risk profiler module 320, a risk manager profiler module 322, a resource allocator module 324 and a user interface 326 for reporting results.

The allocation datamart module 302 is a repository that is specific to a system and stores the results of the risk profiler module 320. The datamart module 302 also uses these contents for metadata trend analyses. The corporate information warehouses module 304 include a variety of enterprise-wide information warehouses that an enterprise uses to store global project related data.

The data service manager module 310 is responsible for interfacing with data storage and retrieval functions. Utility functions include the query executor module 308, which interfaces with the corporate information warehouses module 304 to extract data, as well as the storage manager module 306, which interfaces directly with the allocation datamart module 302 to store system results and metadata.

The project profiler module 312 creates the profile of a project based on the projection of how a project will behave financially in the near future, and includes the data processor module 314, the Budobust auto regressive executor module 316 and the model manager module 318. The data processor module 314: allocates a project to a set of previously defined categories, and takes the project, defined within its categorical boundary, and stores it into two time zones. These time zones can be based on seasonality and absolute time. The Bundobust auto regressive executor module 316 executes a specialized auto regressive algorithm using the data from the data processor module against each time dimension. The result is the creation of a financial model per time scale. Also, the model manager module 318 takes the output from the Bundobust auto regressive executor module and combines the two financial models generated along the seasonal time scale and the absolute time scale. The result is an integrated model that depicts how a project will behave financially in the near future.

The risk profiler module 320 takes the data from the project profiler module 312, risk manager profiler module 322, and other data from the corporate warehouse as needed to identify, using statistics, the right manager for the project in question. The risk manager profiler module 322 uses data mining techniques and enterprise rules to comb through the data extracted from the corporate warehouses to identify managers who have successfully managed the risks associated with projects falling within the same category constraints. The resource allocator module 324 takes the information from risk profiler module 320 and invokes the user interface module 326 to display results. The resource allocator module also stores the resulting pairing and invokes data services to store this information in the allocation datamart module 302.

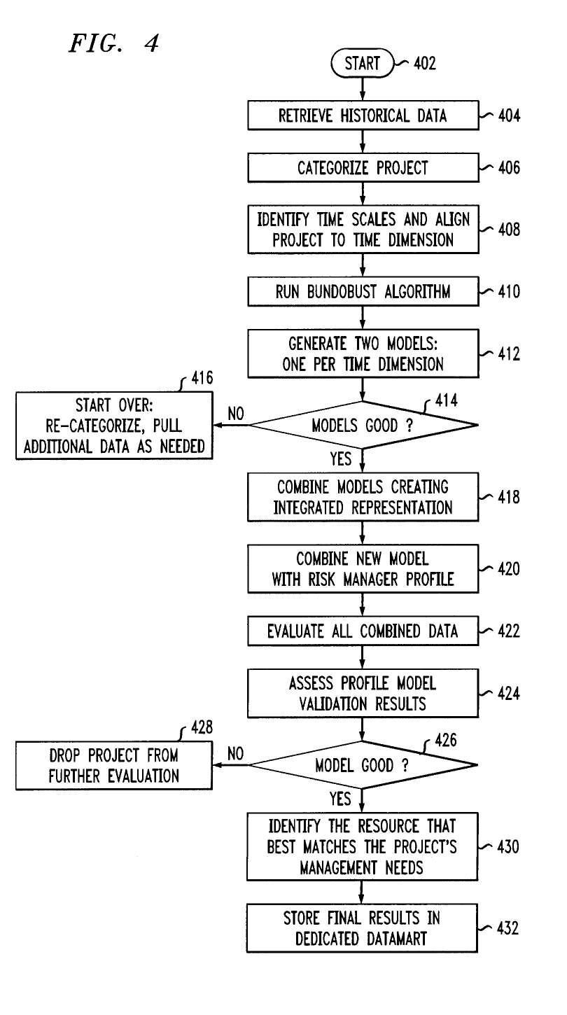

FIG. 4 is a flow diagram illustrating techniques for estimating future health of a project, according to an embodiment of the invention. Step 402 includes starting the techniques. Step 404 includes retrieving historical data. Step 406 includes categorizing the project. Step 408 includes identifying time scales and aligning the project to a time dimension. Step 410 includes running the Bundobust algorithm. Step 412 includes generating two models, one per time dimension. Step 414 includes determining if the models are acceptable. If they are not, then proceed to step 416, which includes starting over; that is, re-categorizing and pulling additional data as needed. If the models are acceptable, then proceed to step 418, which includes combining the models to create an integrated representation.

Step 420 includes combining the new model with a risk manager profile. Step 422 includes evaluating all of the combined data. Step 424 includes assessing the profile model validation results. Step 426 includes determining if the models are acceptable. If they are not, then proceed to step 428, which includes dropping the project from further evaluation. If the models are acceptable, then proceed to step 430, which includes identifying the resource that best matches the project's management needs. Step 432 includes storing the final results in a dedicated datamart.

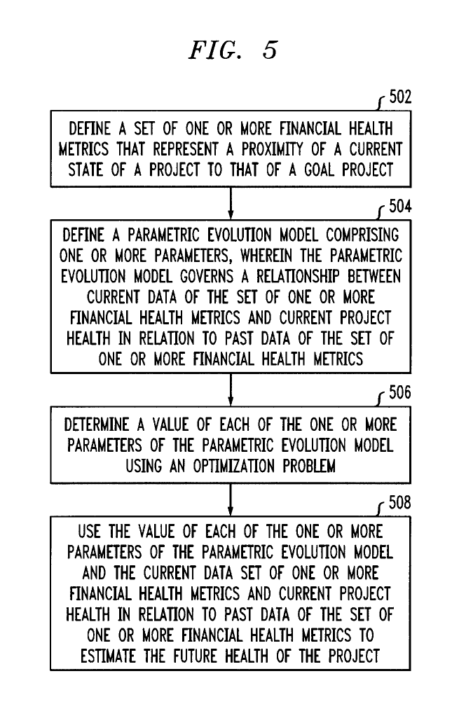

FIG. 5 is a flow diagram illustrating techniques for estimating future health of a project, according to an embodiment of the present invention. Step 502 includes defining a set of one or more financial health metrics that represent a proximity of a current state of a project to that of a goal project. This step can be carried out, for example, using a project profiler module (as well as, for example, a data processor module). A goal project can be, for example, based on user preference, one or more predetermined financial attributes of the project, etc.

By way of example, a financial health metric can include a profit metric. Defining a set of financial health metrics that represent a proximity of a current state of a project to that of a goal project can additionally include defining one or more variables for each of the one or more financial health metrics. Such variables can include, for example, cost, revenue, a revenue error at a given time, a cost error at a given time (wherein the cost/revenue error corresponds to a deviation of a past cost/revenue measurement from a future cost/revenue observation), etc.

Step 504 includes defining a parametric evolution model comprising one or more parameters, wherein the parametric evolution model governs a relationship between current data of the set of one or more financial health metrics and current project health in relation to past data of the set of one or more financial health metrics. This step can be carried out, for example, using a project profiler module (as well as, for example, a data processor module and/or Bundobust auto regressive executor module). A parametric evolution model can include, for example, using a linear estimation approach. For example, see the determinations of variables a, b, and d variables in equation 2 and equation 3, as detailed herein.

Step 506 includes determining a value of each of the one or more parameters of the parametric evolution model using an optimization problem. This step can be carried out, for example, using a project profiler module (as well as, for example, a Bundobust auto regressive executor module and/or model manager module).

Step 508 includes using the value of each of the one or more parameters of the parametric evolution model and the current data of the set of one or more financial health metrics and current project health in relation to past data of the set of one or more financial health metrics to estimate the future health of the project. This step can be carried out, for example, using a project profiler module (as well as, for example, a Bundobust auto regressive executor module and/or model manager module). Using the value of each parameter of the parametric evolution model and the current data of the financial health metrics and current project health in relation to past data of the financial health metrics to estimate the future health of the project can include estimating the future health of the project for a user-selected period of time.

The techniques depicted in FIG. 5 also include enabling delivery management effort allocation across a portfolio of one or more projects, which can include, for example, estimating the future health of each of the one or more projects in the portfolio, and allocating one or more delivery management resources inversely proportional to the future health of each of the one or more projects in the portfolio.

The techniques depicted in FIG. 5 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In one or more embodiments, the modules include a project profiler module that can run, for example on one or more hardware processors. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in one or more embodiments of the invention, the computer program product can include computer useable program code that is stored in a computer readable storage medium in a server data processing system, and wherein the computer useable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

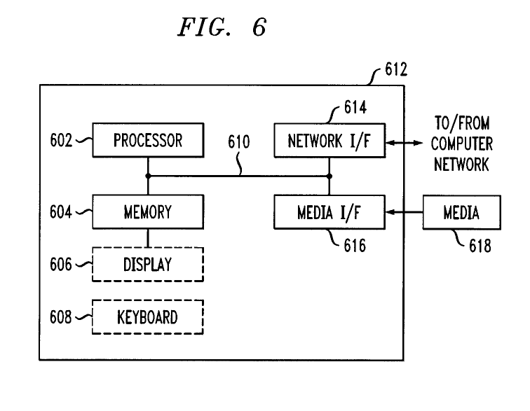

One or more embodiments can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 618 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 3. The method steps can then be carried out using the distinct software modules and/or sub-modules of the system, as described above, executing on one or more hardware processors 602. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one embodiment of the invention may provide one or more beneficial effects, such as, for example, delivery management effort allocation using two time dimension, namely, seasonal variation and project phase variation.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art.

What is claimed is:

1. A method for estimating future health of a project, wherein the method comprises:
defining a set of one or more financial health metrics that represent a proximity of a current state of a project to that of a goal project;
defining a parametric evolution model comprising one or more parameters, wherein the parametric evolution model governs a relationship between current data of the set of one or more financial health metrics and current project health in relation to past data of the set of one or more financial health metrics;
determining a value of each of the one or more parameters of the parametric evolution model using an optimization problem; and
using the value of each of the one or more parameters of the parametric evolution model and the current data of the set of one or more financial health metrics and current project health in relation to past data of the set of one or more financial health metrics to estimate the future health of the project.

2. The method of claim 1, further comprising enabling delivery management effort allocation across a portfolio of one or more projects.

3. The method of claim 2, wherein enabling delivery management effort allocation across a portfolio of one or more projects comprises:
estimating the future health of each of the one or more projects in the portfolio; and
allocating one or more delivery management resources inversely proportional to the future health of each of the one or more projects in the portfolio.

4. The method of claim 1, wherein defining a set of one or more financial health metrics that represent a proximity of a current state of a project to that of a goal project further comprises defining one or more variables for each of the one or more financial health metrics.

5. The method of claim 4, wherein the one or more variables comprise cost.

6. The method of claim 4, wherein the one or more variables comprise revenue.

7. The method of claim 4, wherein the one or more variables comprise a revenue error at a given time, wherein the revenue error corresponds to a deviation of a past revenue measurement from a future revenue observation.

8. The method of claim 4, wherein the one or more variables comprise a cost error at a given time, wherein the cost error corresponds to a deviation of a past cost measurement from a future cost observation.

9. The method of claim 1, wherein using the value of each of the one or more parameters of the parametric evolution model and the current data of the set of one or more financial health metrics and current project health in relation to past data of the set of one or more financial health metrics to estimate the future health of the project comprises estimating the future health of the project for a user-selected period of time.

10. The method of claim 1, wherein the parametric evolution model comprises using a linear estimation approach.

11. The method of claim 1, wherein the one or more financial health metrics comprise a profit metric.

12. The method of claim 1, wherein a goal project is based on user preference.

13. The method of claim 1, wherein a goal project is based on one or more predetermined financial attributes of the project.

14. The method of claim 1, further comprising providing a system, wherein the system comprises one or more distinct software modules, each of the one or more distinct software modules being embodied on a tangible computer-readable recordable storage medium, and wherein the one or more distinct software modules comprise a project profiler module.

15. A computer program product comprising a tangible computer readable recordable storage medium including computer useable program code for estimating future health of a project, the computer program product including:
computer useable program code for defining a set of one or more financial health metrics that represent a proximity of a current state of a project to that of a goal project;
computer useable program code for defining a parametric evolution model comprising one or more parameters, wherein the parametric evolution model governs a relationship between current data of the set of one or more financial health metrics and current project health in relation to past data of the set of one or more financial health metrics;
computer useable program code for determining a value of each of the one or more parameters of the parametric evolution model using an optimization problem; and
computer useable program code for using the value of each of the one or more parameters of the parametric evolution model and the current data of the set of one or more financial health metrics and current project health in relation to past data of the set of one or more financial health metrics to estimate the future health of the project.

16. The computer program product of claim 15, further comprising computer useable program code for enabling delivery management effort allocation across a portfolio of one or more projects.

17. The computer program product of claim 16, wherein the computer useable program code for enabling delivery management effort allocation across a portfolio of one or more projects comprises:
computer useable program code for estimating the future health of each of the one or more projects in the portfolio; and
computer useable program code for allocating one or more delivery management resources inversely proportional to the future health of each of the one or more projects in the portfolio.

18. The computer program product of claim 15, wherein a goal project is based on user preference.

19. The computer program product of claim 15, wherein a goal project is based on one or more predetermined financial attributes of the project.

20. A system for estimating future health of a project, comprising:
a memory; and
at least one processor coupled to the memory and operative to:
define a set of one or more financial health metrics that represent a proximity of a current state of a project to that of a goal project;
define a parametric evolution model comprising one or more parameters, wherein the parametric evolution model governs a relationship between current data of the set of one or more financial health metrics and current project health in relation to past data of the set of one or more financial health metrics;
determine a value of each of the one or more parameters of the parametric evolution model using an optimization problem; and
use the value of each of the one or more parameters of the parametric evolution model and the current data of the set of one or more financial health metrics and current project health in relation to past data of the set of one or more financial health metrics to estimate the future health of the project.

21. The system of claim 20, wherein the at least one processor coupled to the memory is further operative to enable delivery management effort allocation across a portfolio of one or more projects.

22. The system of claim 21, wherein the at least one processor coupled to the memory operative to enable delivery management effort allocation across a portfolio of one or more projects is further operative:
estimate the future health of each of the one or more projects in the portfolio; and
allocate one or more delivery management resources inversely proportional to the future health of each of the one or more projects in the portfolio.

23. The system of claim 20, wherein a goal project is based on user preference.

24. The system of claim 20, wherein a goal project is based on one or more predetermined financial attributes of the project.

25. An apparatus for estimating future health of a project, the apparatus comprising:
means for defining a set of one or more financial health metrics that represent a proximity of a current state of a project to that of a goal project;
means for defining a parametric evolution model comprising one or more parameters, wherein the parametric evolution model governs a relationship between current data of the set of one or more financial health metrics and current project health in relation to past data of the set of one or more financial health metrics;
means for determining a value of each of the one or more parameters of the parametric evolution model using an optimization problem; and
means for using the value of each of the one or more parameters of the parametric evolution model and the current data of the set of one or more financial health metrics and current project health in relation to past data of the set of one or more financial health metrics to estimate the future health of the project.
